(19) United States
(12) Patent Application Publication
(10) Pub. No.: US 2008/0259633 A1
(43) Pub. Date: Oct. 23, 2008

(54) Soft light-transportable tube

(76) Inventor: Wan-Chu Wang, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/785,778

(22) Filed: Apr. 20, 2007

(51) Int. Cl. F21V 33/00

(52) U.S. Cl. 362/577; 362/551; 362/582

(57) ABSTRACT

The invention relates to a soft light-transportable tube, which connect with a lighting apparatus at one end or both ends. The soft tube is made of light-transportable material, which has a lot of tiny apertures formed evenly therein to reflect ray emitted from the lighting apparatus again and again in order that the entire tube can lightened. Hence, the decoration formed by the tube display a perfect lighting effect with improvement and utilization.

### BACKGROUND OF THE INVENTION

Lighting decorations are popular in these days. For example, a traditional decoration is shown in FIG. 1, which uses many bulb assemblies (1) being connected together to form a net structure, wherein the only lighting position is at the bulbs (11). Another conventional decoration is shown in FIG. 2, which includes a transparent board (3) to engage with bulb assemblies (1) directly at back side. As shown in FIGS. 3 and 4, a known tube lamp (4) includes some lighting bulbs (41) received in the tube lamp (4), which can be bent to form various outlook. But the lighting bulbs (41) are always broken or have a short circuit. The cost of manufacturing is high and trouble. In FIG. 5, it is another prior soft fluorescent stick (5), which includes fluorescent material received in the stick (5). In use, the stick (5) must be bent first for incurring the fluorescent material to emit fluorescent light, which can only keep a short time and cannot be used repeatedly. There is another known hard light-transportable stick (6) shown in FIG. 6, which includes some light-transportable liquid received therein for reflecting light. Since this stick (6) is rigid, it is easily broken and is lack of useful.

### SUMMARY OF THE INVENTION

It is therefore a primary object of the present invention to provide a soft light-transportable tube overcome the drawbacks of all prior art and to obtain the best lighting decoration being capable of forming any desired configuration. Now, accompanying with the following drawings, the character of the present invention will be described here and after.

### BRIEF DESCRIPTION OF THE DRAWINGS

FIG. 1 is a plan view showing a traditional net type lighting decoration.

FIG. 2 is a plan view showing a conventional lighting board.

FIG. 3 is a perspective view showing a prior lighting tube.

FIG. 4 is a cross-sectional plan view of FIG. 3.

FIG. 5 is a perspective view showing a known fluorescent stick.

FIG. 6 is a perspective view showing a known hard light-transportable stick.

FIG. 7 is a perspective view showing a first embodiment of a soft light-transportable tube according to the present invention.

FIG. 8 is a perspective view showing a second embodiment of a soft light-transportable tube according to the present invention.

FIG. 9 is a plan view showing a third embodiment of a soft light-transportable tube according to the present invention.

FIG. 10 is a plan view showing a fourth embodiment of a soft light-transportable tube according to the present invention.

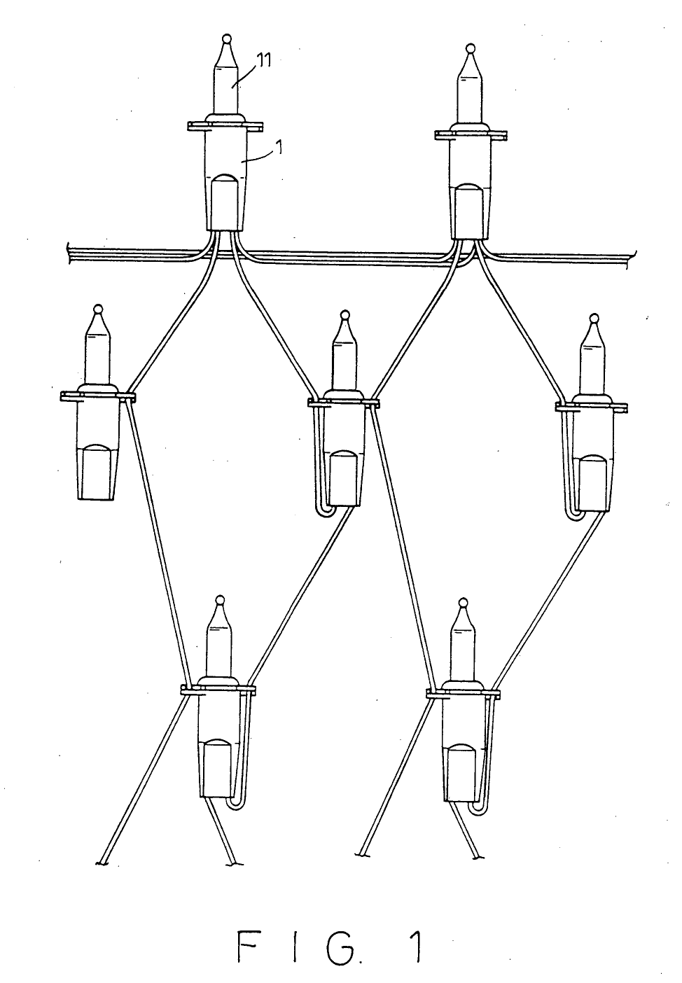

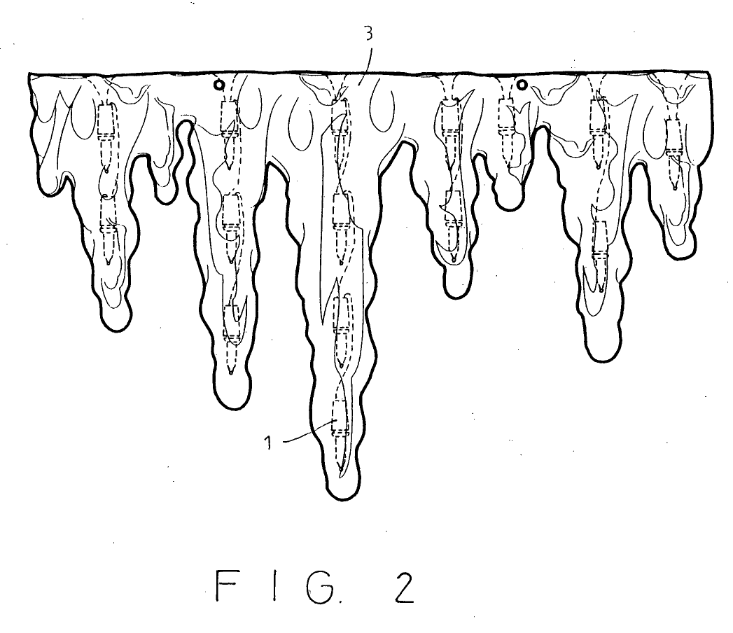

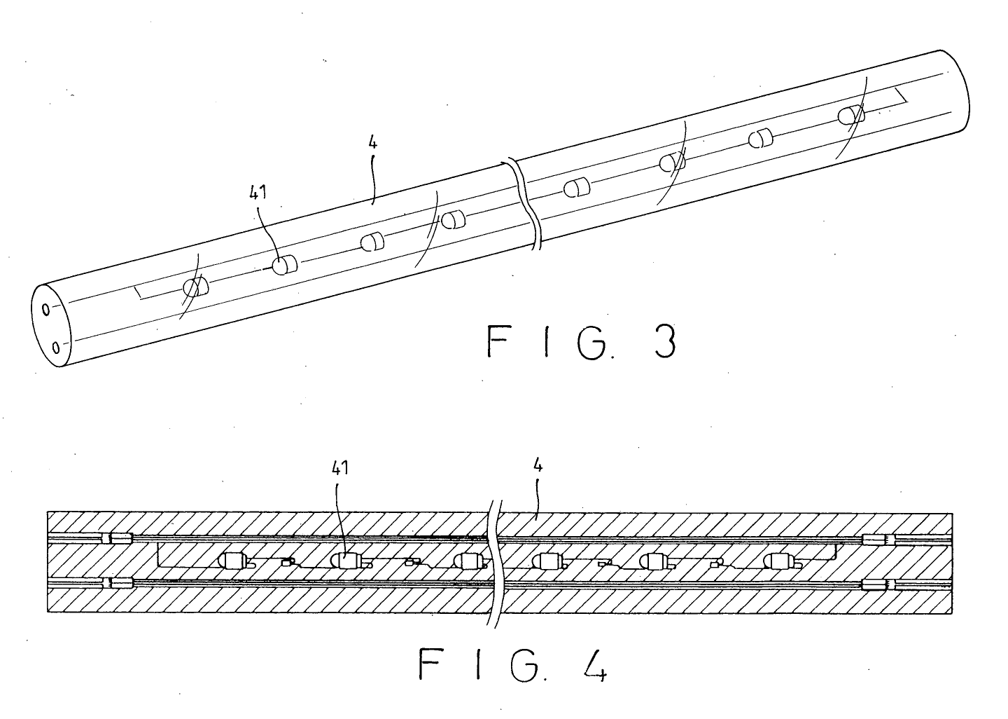

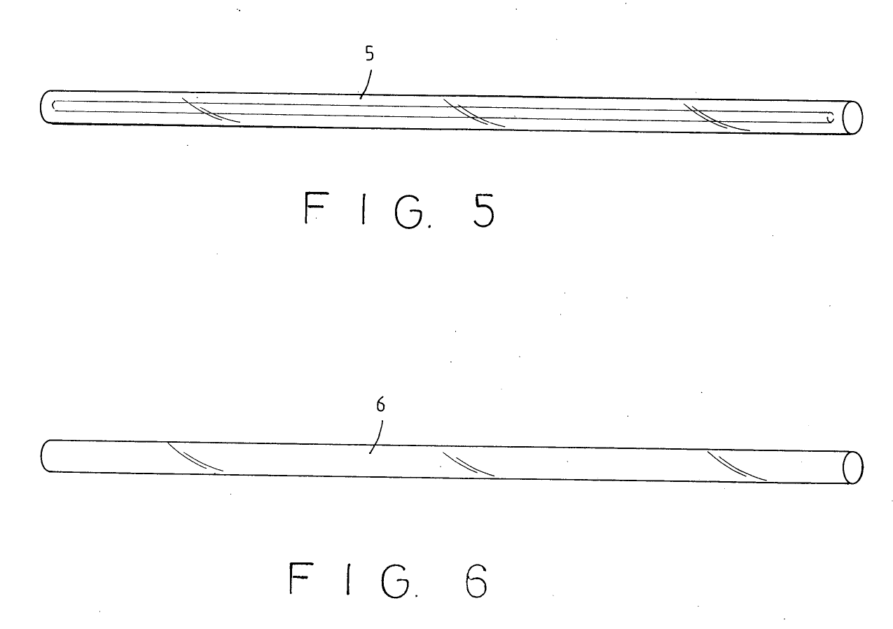

### DETAILED DESCRIPTION OF THE PREFERRED EMBODIMENT

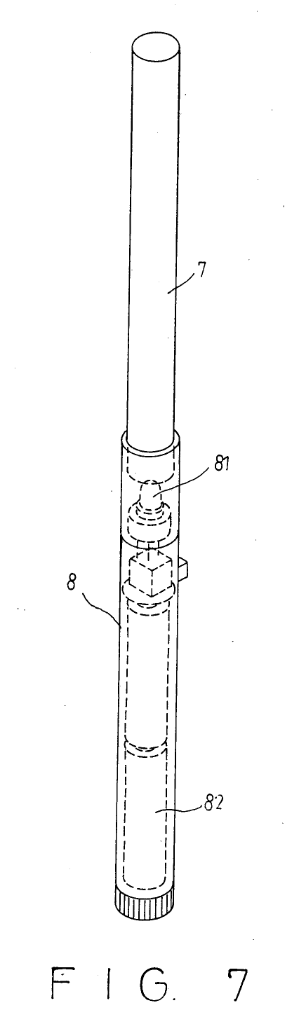

The present invention relates to a soft light-transportable tube (7), which is made of soft material with a perfect character of light-transportation. The tube (7) connects with a lighting apparatus (8) at one end. Such as shown in FIG. 7, the lighting apparatus (8) includes a bulb (81) and batteries (82). When the bulb (81) is lightened, the lighting ray may be transported and reflected from the entire tube (7). The theory is that the made material of the tube (7), which includes a lot of tiny apertures formed evenly. When the lighting ray emits into the tube (7), it is reflected again and again, hence the entire tube (7) is lightened with perfect lighting outlook.

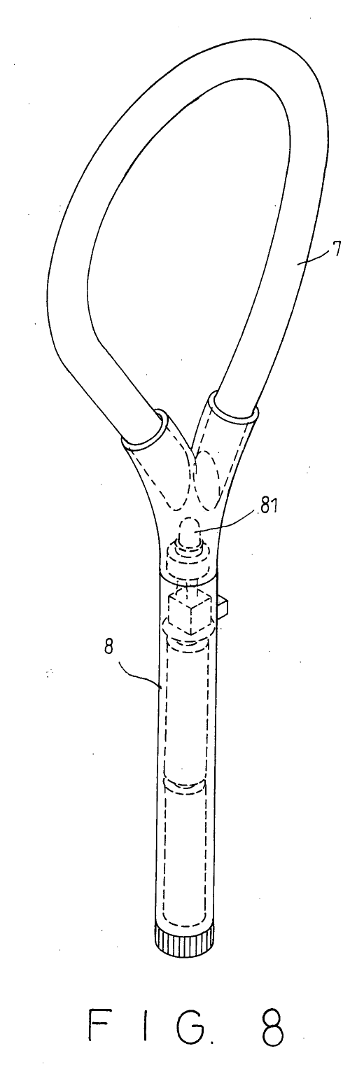

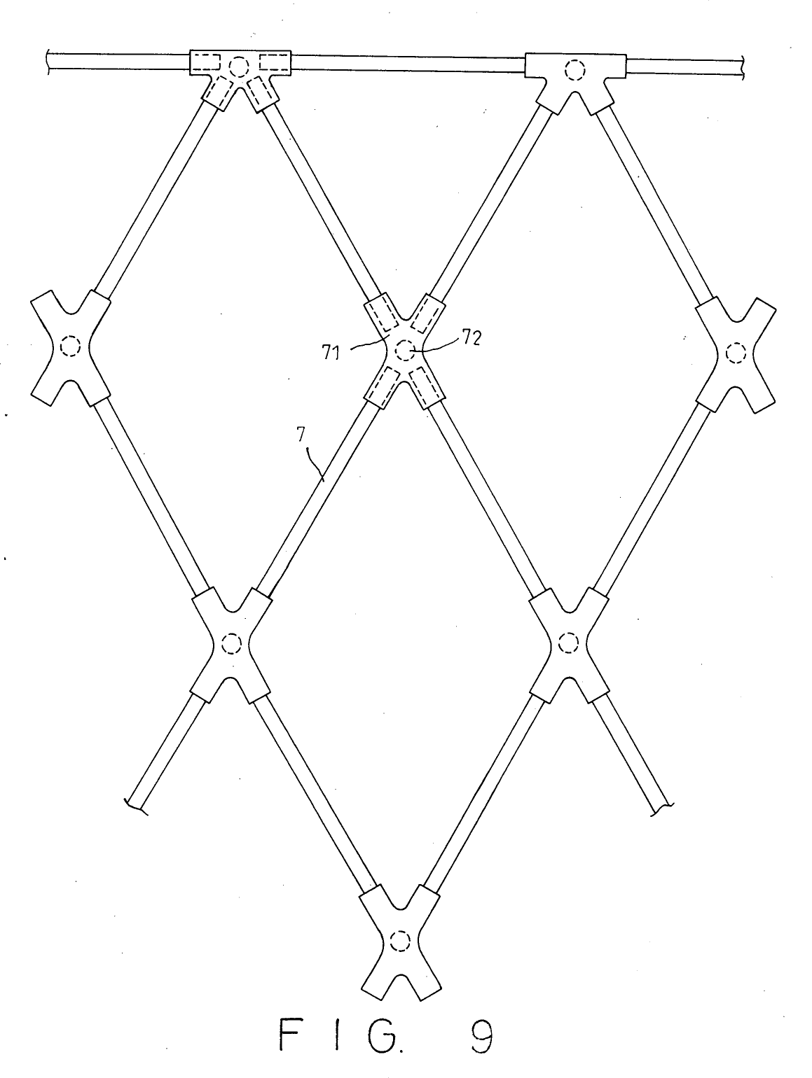

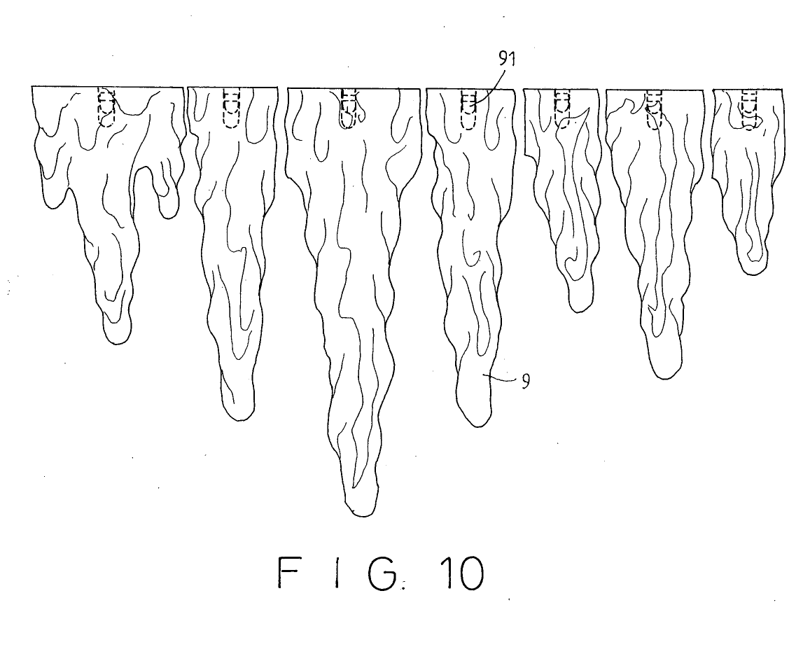

In application, since the tube (7) according to the present invention is soft, it can be bent around other decorations or formed to be a new decoration. Such as shown in FIG. 8, the tube (7) is bent to be a ring and connected with the lighting apparatus (8), wherein the bulb (81) emits light into the tube (7) through both ends. In FIG. 9, it shows another embodiment of the present invention, which uses several tubes (7) connected together by related connector (71) having inner bulbs (72) to obtain a lighting net decoration with better lighting effect. Referring to FIG. 10, it shows a decorative board (9) made of the same material as the tube (7). The board (9) connects with bulbs (91) only at top end that may cause the entire board (9) lightened to display a pretty outlook.

While preferred embodiments of the invention have been shown and described in detail, it will be readily understood and appreciated that numerous omissions, changes and additions may be made without departing from the spirit and scope of the invention. That is the above mentioned embodiment is only exemplary and is not to limit the scope of the invention. Any modification with the same merit will be still claimed in the present invention.

I claim:

1. A soft light-transportable tube connecting a lighting apparatus at one end or both ends, the tube being made of light-transportable material having a lot of tiny apertures formed evenly to reflect ray from the bulb again and again that the entire tube is lightened.

2. The soft light-transportable tube as claimed in claim 1, wherein the tube can be bent to form various outlook and to put around other decorations directly.

3. The soft light-transportable tube as claimed in claim 1, wherein the tubes are connected together by connectors to form a lighting net decoration.

4. The soft light-transportable tube as claimed in claim 1, wherein the tube is transformed to be different lighting configurations made the same material.
